(19) United States
(12) Patent Application Publication
(10) Pub. No.: US 2020/0132236 A1
(43) Pub. Date: Apr. 30, 2020

(54) PIPING UNIT WITH HEAT EXCHANGE STRUCTURE

(71) Applicants: ROKI CO., LTD., Hamamatsu-Shi (JP); HONDA MOTOR CO., LTD., Tokyo (JP)

(72) Inventors: Takahisa AKITA, Hamamatsu-Shi (JP); Masaharu Hirai, Hamamatsu-Shi (JP); Akira Uchiyama, Hamamatsu-Shi (JP); Yuichiro Yano, Hamamatsu-Shi (JP); Hidemasa Usui, Wako-Shi (JP); Yuta Abe, Wako-Shi (JP)

(73) Assignees: ROKI CO., LTD., Hamamatsu-Shi (JP); HONDA MOTOR CO., LTD., Tokyo (JP)

(21) Appl. No.: 16/660,942

(22) Filed: Oct. 23, 2019

(30) Foreign Application Priority Data
Oct. 25, 2018 (JP) 2018-201108

(51) Int. Cl. F16L 53/70; F16L 9/22; F16L 9/127

(52) U.S. Cl. CPC F16L 53/70; F16L 9/127; F16L 9/22

(57) ABSTRACT

The present invention provides a piping unit that facilitates downsizing of a cooler by decreasing the temperature of fluid to be introduced into the cooler without reducing the cooling effect of a cooler. A piping unit is for introduction of heated fluid into a cooler, the piping unit being formed from synthetic resin and including a heat exchange structure on an inner peripheral surface.

### BACKGROUND OF THE INVENTION

### Field of the Invention

The present invention relates to a piping unit for introduction of fluid, and more particularly to a piping unit having a heat exchange structure for dissipating heat of heated fluid before introduction of the heated fluid into a cooler and the like or for transferring heat to cooled fluid before introduction of the cooled fluid.

### Description of the Related Art

Known conventional devices for cooling heated fluid, such as air and coolant, in an internal combustion engine or the like include cooling devices that cool fluid using a cooler such as an intercooler or a radiator.

As shown in Japanese Patent Laid-Open No. 2007-182871, for instance, a piping structure that directs pressurized air from a supercharger into an intercooler for cooling therein is known. The piping structure shown in Japanese Patent Laid-Open No. 2007-182871 has strength enough for preventing deformation under pressurized air having a pressure increased by a supercharger. The piping structure also has a prescribed cross-sectional area of a joint relative to a cross sectional area of a flow passage at a distal end of a header tank in order to reduce stress on a tube root of an intercooler.

It is also a known practice to attach an insulator to an internal combustion engine to control increase in temperatures of metallic parts in order to suppress heat coming from the internal combustion engine and/or heat dissipation around the internal combustion engine. As shown in Japanese Patent Laid-Open No. 2010-203310, for instance, a heat insulator that provides heat dissipation effect by forming insulator surfaces with a predetermined roughness to increase surface roughness is known.

Since these conventional coolers have a function of cooling introduced fluid, they require securing of a certain contact area to achieve a desired cooling effect, having a problem of difficulty in downsizing the cooler itself. In view of automobile downsizing in recent years and/or improvement in fuel efficiency associated with reduction in weight, however, there is a demand for downsizing of the cooler itself.

One possible way is to decrease the temperature of heated fluid to be introduced into the cooler for reducing the size of the cooler. However, sufficient heat dissipation effect cannot be achieved with conventional heat dissipation structures, such as one with a piping unit wrapped with heat insulator or one with an increased contact area provided by an increased surface roughness of an outer surface of a piping unit. Thus, there has been the problem of difficulty in sufficient downsizing of a cooler and still being unable to reduce the cooler size.

### SUMMARY OF THE INVENTION

The present invention was made in view of such a problem, and an object thereof is to provide a piping unit that facilitates downsizing of a cooler by decreasing the temperature of fluid to be introduced into the cooler without reducing the cooling effect of a cooler.

A piping unit according to the present invention is for introduction of heated fluid, wherein the piping unit is formed from synthetic resin and includes a heat exchange structure on an inner peripheral surface.

In the piping unit according to the present invention, the heat exchange structure is preferably an asperity geometry formed on the inner peripheral surface of the piping unit.

In the piping unit according to the present invention, the heat exchange structure is preferably a rib erected on the inner peripheral surface of the piping unit.

The piping unit according to the present invention is preferably constructed of a combination of at least a first segment and a second segment.

The piping unit according to the present invention preferably includes a bent portion.

In the piping unit according to the present invention, the fluid is preferably compressed and heated by a supercharger.

The summary of the invention above is not an exhaustive listing of essential features of the present invention and any sub-combination of these features may also fall in the invention.

Since the piping unit according to the present invention has a heat exchange structure on its inner peripheral surface, it can efficiently dissipate the heat of heated fluid flowing in the piping unit or transfer heat to cooled fluid without degrading air flow resistance. The temperature of fluid to be introduced into a cooler and the like can thereby be decreased or increased, so that downsizing of the cooler is facilitated without lowering of cooling efficiency of the cooler and the like.

### BRIEF DESCRIPTION OF THE DRAWINGS

FIG. 1 illustrates a configuration of a supercharger system to which a piping unit according to an embodiment of the present invention is applied;

FIG. 2 is a perspective view of the piping unit according to the embodiment of the present invention;

FIG. 3 is an exploded view of the piping unit according to the embodiment of the present invention;

FIG. 4 illustrates a heat exchange structure according to the embodiment of the present invention;

FIG. 5 is a graph illustrating a heat exchange effect of the piping unit according to the embodiment of the present invention;

FIG. 6 is a graph showing results of measuring a air flow resistance of the piping unit according to the embodiment of the present invention;

FIG. 7 is a graph showing results of measurement of the heat exchange effect with different bending angles of the piping unit according to the embodiment of the present invention; and

FIG. 8 is a cross-sectional view showing a variant of the piping unit according to the embodiment of the present invention.

### DETAILED DESCRIPTION OF THE PREFERRED EMBODIMENT

A preferred embodiment for practicing the present invention is described below with reference to the drawings.

The embodiment described below is not intended to limit the subject matters set forth in the claims and not all of the combinations of features described in the embodiment are essential for a solution of the present invention.

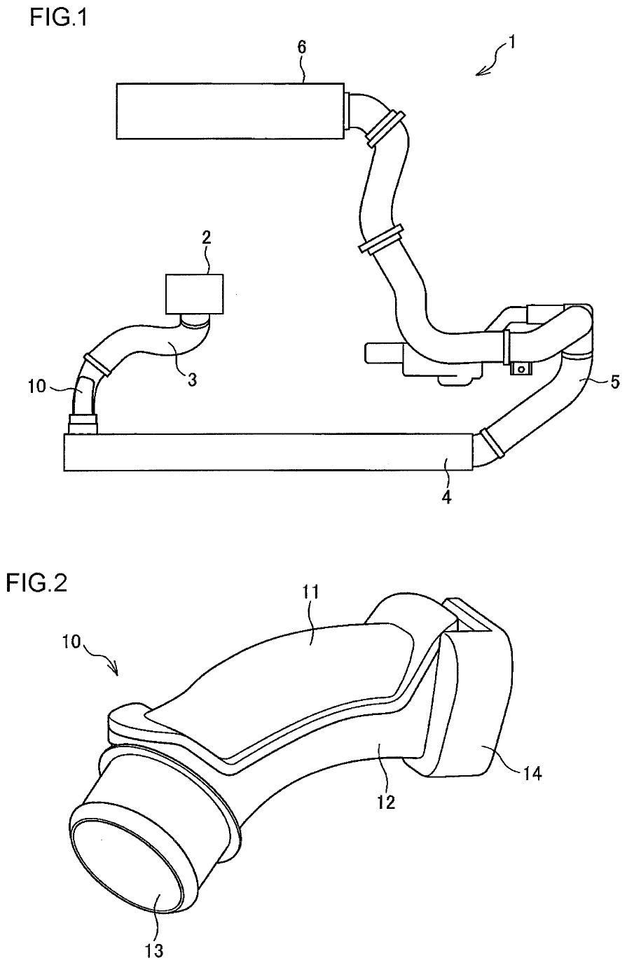

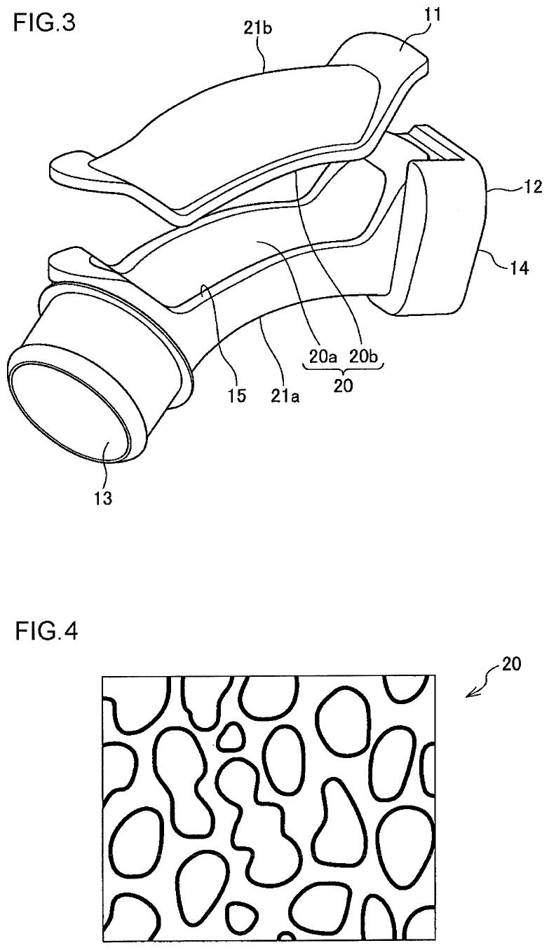

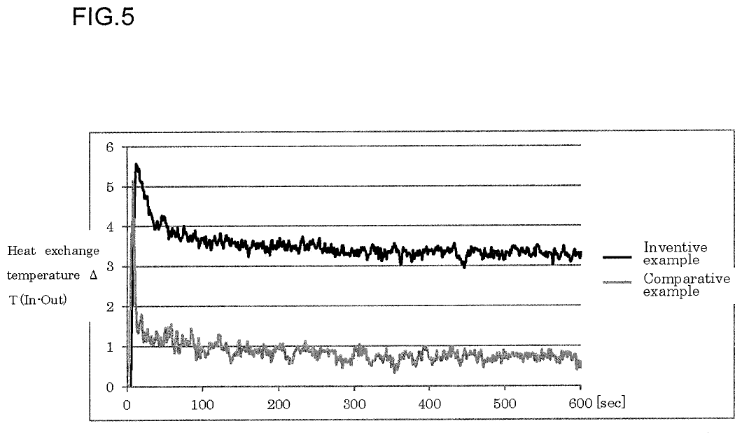

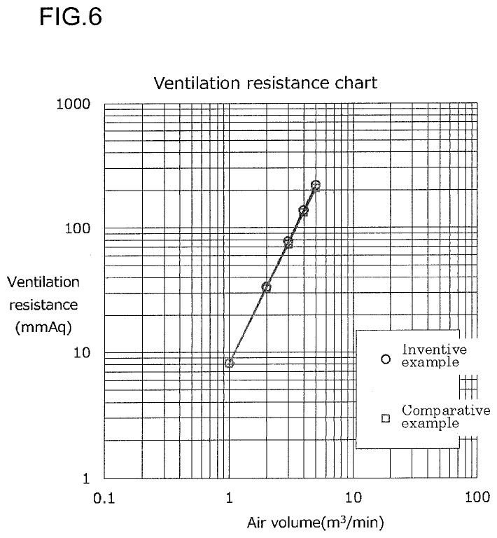

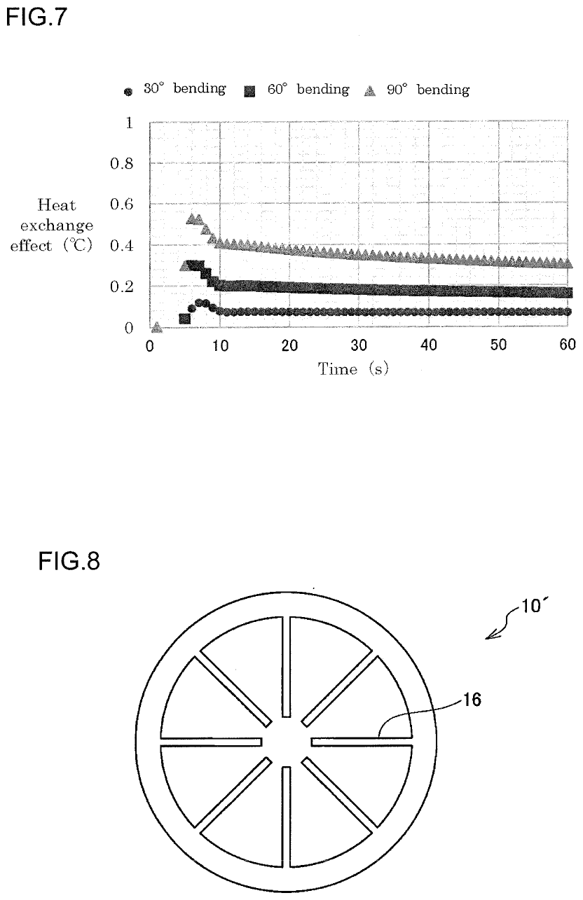

FIG. 1 illustrates a configuration of a supercharger system to which a piping unit according to an embodiment of the present invention is applied; FIG. 2 is a perspective view of the piping unit according to the embodiment of the present invention; FIG. 3 is an exploded view of the piping unit according to the embodiment of the present invention; FIG. 4 illustrates a heat exchange structure according to the embodiment of the present invention; FIG. 5 is a graph illustrating the heat exchange effect of the piping unit according to the embodiment of the present invention; FIG. 6 is a graph showing results of measuring the air flow resistance of the piping unit according to the embodiment of the present invention; FIG. 7 is a graph showing results of measurement of the heat exchange effect with different bending angles of the piping unit according to the embodiment of the present invention; and FIG. 8 is a cross-sectional view showing a variant of the piping unit according to the embodiment of the present invention.

FIG. 1 shows a supercharger system 1 including a piping unit 10 according to an embodiment of the present invention. The piping unit 10 introduces fluid that has been pressurized and heated by a supercharger 2, such as a turbo charger, into a cooler 4 such as an intercooler, and is installed between a high-temperature-side piping unit 3 and the cooler 4. Fluid cooled by the cooler 4 is supplied to an internal combustion engine 6 through a low-temperature-side piping unit 5. As the supercharger 2 and the cooler 4 have conventional, well-known configurations, they are not described in detail herein. The high-temperature-side piping unit 3 and the low-temperature-side piping unit 5 are each preferably formed from thermoplastic synthetic resin, such as polypropylene-based resin or polyamide-based resin.

Such a supercharger system 1 can produce higher combustion energy by increasing a density of external air to be supplied to the internal combustion engine 6 at the supercharger 2 and sending more oxygen to a combustion chamber. Consequently, it can provide sufficient output even with an internal combustion engine of smaller displacement, thus allowing improvement in fuel efficiency associated with the smaller displacement of the internal combustion engine

As shown in FIG. 2, the piping unit 10 with the heat exchange structure according to this embodiment is a tubular component constructed by welding a first segment 11 and a second segment 12 together, and has an inflow port 13 to be mounted to the high-temperature-side piping unit 3 and an outflow port 14 to be mounted to the cooler 4. The piping unit 10 also has a bent portion, which is bent in a curved shape from the inflow port 13 toward the outflow port 14. The first segment 11 and the second segment 12 making up the piping unit are each formed from synthetic resin, preferably from thermoplastic synthetic resin such as polypropylene-based resin or polyamide-based resin. For the synthetic resin, material with high heat conductivity is preferably used.

As shown in FIG. 3, the first segment 11 is a component which is welded so as to close an opening 15 formed in the second segment 12, and preferably is located on an outer peripheral side of the bent portion of the piping unit 10. That is, preferably, the first segment 11 is positioned on the outer peripheral side and the second segment 12 is positioned on an inner peripheral side in the bent portion of the piping unit 10. Also, any of various joining devices may be used for the first segment 11 and the second segment 12. For example, vibration welding, ultrasonic welding, thermal welding or the like are suitable for use, or adhesive and various fastening devices, such as bolts and nuts, screws, and clips, may also be used.

On inner peripheral surfaces of the first segment 11 and the second segment 12, a heat exchange structure 20 composed of inner heat exchange structures 20a, 20b having a certain asperity geometry is formed. Preferably, outer heat exchange structures 21a, 21b having a similar asperity geometry to that of the heat exchange structure 20 are further formed on outer surfaces of the first segment 11 and the second segment 12 as well. The asperity geometry may be formed on the entire inner and outer peripheral surfaces; however, they may instead be formed only in portions with high heat exchange effect, and other portions may be smooth inner or outer peripheral surfaces as in conventional practices.

As shown in FIG. 4, the heat exchange structure 20 is formed as minute asperity geometry; specifically, it can be formed by applying grain texture to dies used for molding of the first segment 11 and the second segment 12. Also, recessed portions of the asperity geometry may be formed at any depth as long as it can be set within a range that does not affect the air flow resistance of fluid flowing through the piping unit 10, but preferably they are formed at a depth of 300 μm or less, for example. As an increase in an inner diameter of the piping unit 10 allows reduction in the air flow resistance, the inner diameter of the piping unit 10 can be set in consideration of the heat exchange effect provided by the asperity geometry and influence on the air flow resistance.

For a pattern of the grain texture, various known grain texture geometries can be applied, among which a speckle grain geometry such as shown in FIG. 4, for example, is preferable because it is easiest to make and can provide for a largest surface area.

In this manner, provision of the heat exchange structure 20 at least on the inner peripheral surface of the piping unit 10 increases the contact area between the fluid flowing in the piping unit 10 and its inner peripheral surface, which can enhance the heat exchange effect of heated fluid. Also in synergy with the outer heat exchange structures 21a, 21b formed on the outer peripheral side, the temperature of fluid to enter the cooler 4 can be decreased, facilitating downsizing of the cooler 4. In addition, as the asperity geometry is set within a range that does not affect the air flow resistance, degradation of the air flow resistance can be prevented despite formation of the heat exchange structure 20 on the inner peripheral surface of the piping unit 10.

As discussed later, the heat exchange structure 20 provides higher heat exchange effect when it is formed at a location on the inner peripheral surface of the piping unit 10 that corresponds to the bent portion.

### EXAMPLE

FIG. 5 shows results of measurement of heat exchange temperatures at a fluid temperature of 90° C. for an example of a piping unit with the heat exchange structure 20 according to this embodiment and a conventional piping unit as a comparative example without the heat exchange structure. As is apparent from FIG. 5, it can be seen that the heat exchange temperature in the example indicates that the heat exchange effect is higher than the comparative example by about 2 to 3.5° C. from soon after a start of measurement, and that the heat exchange effect is retained after elapse of 600 seconds.

As to the air flow resistance, as shown in FIG. 6, the example and the comparative example have similar levels of progression of air flow resistance even with increase or decrease in a flow rate of fluid, confirming that the formation of the heat exchange structure on the inner peripheral surface does not affect the air flow resistance.

Further, FIG. 7 shows the results of measurement, which compares the heat exchange effects of different examples in which the bent portion was formed at an angle of 30°, 60°, and 90°, respectively and such a bent portion was provided in the heat exchange structure. As is apparent from FIG. 7, it can be seen that a larger angle of the bent portion results in higher heat exchange effect and that the heat exchange effect is retained even after elapse of time. From this fact, it was confirmed that the heat exchange effect could be enhanced more effectively by the formation of a bent portion in the heat exchange structure according to this embodiment.

While the piping unit 10 according to this embodiment was described above as being provided with an asperity geometry by formation of grain texture on its inner and outer peripheral surfaces, a specific geometry of the heat exchange structure is not limited to it. For example, a rib 16 may be erected on the inner peripheral surface as shown in FIG. 8. In such a case, flow straightening effect could be also provided by forming the rib 16 along a direction in which the fluid flowing in a piping unit 10′ flows. In such a case, the heat exchange effect and the air flow resistance could be adjusted by adjusting a height of the rib 16. The rib may be formed in a linear shape along the direction in which the fluid flows, or alternatively, a helical rib may be formed on the inner peripheral surface, for example.

Although the piping unit 10 according to this embodiment was described above as being composed of the first segment 11 and the second segment 12, the piping unit may also be constructed with three or more segment components.

Although the piping unit according to this embodiment was described above as being applied to a cooler of a supercharger system, an application of the present piping unit is not limited to a supercharger system but may also be applied to a radiator for cooling coolant in an internal combustion engine or a condenser for cooling refrigerant used in an air conditioning system, for example. Also, although the piping unit was described above for a case of dissipating the heat of heated fluid, it may be configured to transfer heat to cooled fluid in order to heat the cooled fluid. It is apparent from the description of claims that forms with such modifications or improvements can also fall in a technical scope of the present invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2018-201108 filed on Oct. 25, 2018 including the specification, claims, drawings and summary is incorporated herein by reference in its entirety.

### REFERENCE SIGNS LIST

1 supercharger system
2 supercharger
3 high-temperature-side piping unit
4 cooler
5 low-temperature-side piping unit
6 internal combustion engine
10 piping unit
11 first segment
12 second segment
13 inflow port
14 outflow port
15 opening
16 rib
20 heat exchange structure
20a, 20b inner heat exchange structure
21a, 21b outer heat exchange structure

1. A piping unit for introduction of heated fluid, wherein the piping unit is formed from synthetic resin and comprises a heat exchange structure at least on an inner peripheral surface.

2. The piping unit according to claim 1, wherein the heat exchange structure is an asperity geometry formed at least on the inner peripheral surface of the piping unit.

3. The piping unit according to claim 1, wherein the heat exchange structure is a rib erected at least on the inner peripheral surface of the piping unit.

4. The piping unit according to claim 1, wherein the piping unit is constructed of a combination of at least a first segment and a second segment.

5. The piping unit according to claim 1, wherein the piping unit comprises a bent portion.

6. The piping unit according to claim 1, wherein the fluid is compressed and heated by a supercharger.
